(19) United States
(12) Patent Application Publication
(10) Pub. No.: US 2004/0086660 A1
(43) Pub. Date: May 6, 2004

(54) Method for the preparation of a substrate for immobilising chemical compounds and the substrate and the use thereof

(76) Inventors: Bjorn Winther-Jensen, Bronshoj (DE); Soren Flygenring Christensen, Kobenhavn O (DE); Steen Guldager Petersen, Rodovre (DE)

Correspondence Address: FINNEGAN, HENDERSON, FARABOW, GARRETT & DUNNER, LLP, 1300 I STREET, NW, WASHINGTON, DC, 20005, US

(21) Appl. No.: 10/451,999

(22) PCT Filed: Dec. 28, 2001
(86) PCT No.: PCT/DK01/00870

(30) Foreign Application Priority Data
Dec. 29, 2000 (DK) PA 2000 01954

(51) Int. Cl. H05H 1/00

(52) U.S. Cl. 427/535

(57) ABSTRACT

The invention relates to a method of providing a solid substrate for immobilizing chemical compounds particular biomolecules. The method comprises the steps of providing a basis substrate, and treating the surface of the basis substrate with a monomer gas in a plasma generated by a power source selected from the group consisting of multiple phase AC supply and multiple DC supply, wherein the intensity of said plasma being at the most 5.0 W/I, such as at the most 3.0 W/I, and said monomer gas comprising one or more types of monomers which is plasma polymerized onto the surface to thereby provide the surface of the solid substrate with chemically reactive groups. The invention also relates to a substrate obtainable by the method, and a process for immobilizing a chemical compound to a surface of such solid substrate. The method is relatively simple and economically feasibly, and the substrate has a high quality and a high concentration of functionalities.

### FIELD OF THE INVENTION

The present invention relates to a method of providing a substrate for immobilising chemical compounds, in particular biomolecules, and analogues and derivatives thereof. The substrate carries chemically reactive groups which are capable of reacting with specific chemical groups of biomolecules such as amines, phosphor esters, thiols and hydroxyls. The invention also relates to the substrate and use of the substrate.

### BACKGROUND OF THE INVENTION

Although a number of techniques for immobilisation of biomolecules (e.g. proteins, lipids, nucleic acid, whole cells or cell fragments) exists, there is still a need for alternative substrates suitable for this purpose, in particular substrates on which the chemically reactive groups are capable of reacting with biomolecules without the need for further activation.

A method of providing a substrate for immobilising chemical compounds such as biomolecuies is e.g. described in WO 96/31557 This method includes an photochemical immobilising. Similar methods are described in U.S. Pat. No. 4,973,493 and U.S. Pat. No. 5,002,582.

Acid halogenides, acid anhydrides, epoxides, aldehydes, etc. can readily undergo reaction with amine groups (in particular primary amines), and these chemically reactive groups are therefore believed to have particular relevance as chemically reactive groups on substrates intended for immobilisation of biomolecules. To the applicant's best knowledge, it has normally been quite difficult and laborious to prepare such functionalised substrates, in particular on an industrial scale.

U.S. Pat. No. 6,303,179 discloses a method of providing a substrate with an amine-functional polymer surface by irradiating the surface of a solid polymer material, grafting the irradiated surface with an amide functional ethylenically unsaturated monomer and converting the amide functional group to an amine functional group.

The objective of the present invention is to provide an alternative method of providing a substrate for immobilising molecules e.g. biomolecules. In particular it is an objective of the present invention to provide a method for preparing a substrate comprising functional groups for immobilising chemical compounds, which method is relatively simple and economically feasible compared to known methods as described above.

Furthermore, it is an objective of the present invention to provide a method for preparing a substrate for immobilising chemical compounds, which method which method is relatively easy to control and can be reproduced with high quality, and wherein it is possible to provide the substrate surface with a relatively high concentration of functional groups which can link to the chemical compounds to be immobilised.

Also it is an objective of the invention to provide a high quality substrate for immobilising chemical compounds, which substrate may be designed with a desired concentration of functional active groups on its surface.

### SUMMARY OF THE INVENTION

The above objectives have been achieved with the invention as defined in the claims. As it will appear from the following description the invention have even further advantages.

In has thus been found that by producing a substrate for immobilising chemical compounds using a low power plasma method it is possible to obtain a substrate of a very high quality, and further more, the method is simple, economically feasible and provides a high flexibility for designing the substrate. Also the method can be used for producing substrates for immobilising a large varity of chemical compounds.

The present invention thus, relates to a novel method of providing functional groups including chemically reactive groups on the surface of a solid substrate by plasma polymerisation, including treatment of the substrate with a monomer gas in a plasma generated by a multiple phase AC supply or a DC supply in order to provide a plasma polymerised layer onto the surface. The monomer gas comprises one or more types of monomers which will give rise to the chemically reactive groups on the surface of the solid substrate.

Furthermore, the present invention relates to a process for coupling a biomolecule or a biomolecule analogue or a derivative thereof to a surface of a solid substrate, the process may include the steps of functionalising the surface of the substrate using the method defined in the claims so as to provide chemically reactive groups on the surface of the substrate, and contacting the surface of the substrate with a solution comprising the biomolecule or biomolecule analogues or derivative thereof so as to allow reaction between the chemically reactive groups of the substrate and the proteins, lipids, cells, cell fractions or nucleic acids or analogues thereof.

### DETAILED DESCRIPTION OF THE INVENTION

The method of providing a solid substrate for immobilising chemical compounds according to the invention comprises the steps of providing a basis substrate, and treating the surface of the basis substrate with a monomer gas in a plasma.

Plasma surface modification techniques are generally known in the art. For example, U.S. Pat. No. 5,876,753 describes a method of applying a fluorocarbon film onto a substrate using an RF plasma polymerisation process.

According to the present invention is has been found that by applying a plasma generated by a power source selected from the group consisting of multiple phase AC supply and multiple DC supply, wherein the intensity of the plasma is at the most 5.0 W/I, such as at the most 3.0 W/I, a substrate of increased quality is provided.

The basic solid substrate may in principle be of any kind of materials or combinations of materials e.g. layered or mixed materials. Typically the solid substrate essentially consists of a material selected from glass, silicon, paper, carbon fibres, ceramics, metals and polymers, e.g. polyolefins such as polyethylene (PE) and polypropylene (PP), polystyrene (PS), or other thermoplastics such as polytetrafluoroethylene (PTFE), tetra-fluoroethylene-hexafluoropropylen-copolymers (FEP), polyvinyl-difluoride (PVDF), polyamides (e.g. nylon-6.6 and nylon-11), and polyvinylchloride (PVC), rubbers e.g. silicon rubbers. Presently preferred materials are polyethylene (PE), polystyrene (PS), silicon, and glass which are well known for use in traditional biochemical applications, and which are compatible with most standardised analytical instrumentation.

The solid substrate may have any shape e.g. shaped as a strip, a plate, a slide, an Eliza plate, a dipstick, and etc.

It should be observed that in the present application the surface of the substrate or “substrate surface” could be one or more sub surface areas, but it could also include the entire surface of the substrate. It should also be observed that the substrate may comprise different chemically reactive groups or different concentrations of chemically reactive groups on different sub surface areas. Thus parts of the substrate may be totally or partly masked during all or part of the plasma treatment and further the substrate may be subjected to two or more plasma treatments e.g. with different masked sub surface areas. Generally it is preferred that the substrate surface which is subjected to a plasma treatment and thereby is provided with chemically reactive groups includes an area of at least 1 my², preferably at least 10 my², more preferably at least 100 my². In some applications the substrate surface, which is subjected to a plasma treatment and thereby is provided with chemically reactive groups includes an area of between 0.01-100 cm² or even larger areas.

The substrate surface may be pre-coated in order to modify the properties thereof, e.g. the ability of the surface to adhere to the plasma polymerised layer, or the hydrophobic properties of the substrate as such. The pre-coating may e.g. be performed by plasma polymerisation. Preferably, the pre-coating provides a substantially homogenous layer of a polymer onto the native surface of the substrate. As an illustrative example, the surface may be pre-coated with a plasma polymerised layer of, e.g., polystyrene (see Example 1).

The chemically reactive groups which are highly desirable within the present invention are such groups which are capable of reacting with biomolecules or biomolecule analogues or derivatives thereof (commonly referred to as “biomolecules” in the following). The reaction may preferably result in an ionic or even more preferred a covalent bonding between the chemically reactive group and the chemical compound. Biomolecules will often include reactive sites such as amino groups, hydroxy groups, thio groups, phosphor ester groups, etc., or biomolecules can be derivatised so as to include such groups, in particular amines such as primary amines. In particular amines of such biomolecules are highly useful for immobilisation to the solid substrates, which can be prepared according to the present invention.

The chemically reactive groups which are provided on the surface of the solid substrate, are preferably groups which can react and thereby bind to a biomolecule, preferably a protein or nucleic acid in a liquid phase reaction not requiring energy input from external sources, e.g., heat, UV-light, electron beam, microwaves, or ultra sound. Typically the binding reaction is carried out in aqueous solution, optionally containing pH-buffers, salts, carbodiimides, or other additives known to those skilled in the art of binding of biomolecules, or in an organic solvent, e.g., acetonitrile, tetrahydrofurane, chloroform, di-chloromethane, ethanol, dimethyl formamide, dimethyl sulfoxide, or in a mixture of two or more organic solvents optionally containing additives known to those skilled in the art of binding of biomolecules.

Examples of functional chemically reactive groups which are found particularly interesting are those selected from acid anhydrides (in particular carboxylic acid anhydrides), acid halides (in particular carboxylic acid halides) such as acid chlorides, acid bromides, acid fluorides, acid iodides, epoxides, aldehydes, carboxylic acids, thiols, nitrites, primary and secondary amines, and phosphate esters, in particular acid anhydrides, acid halides, epoxides, and aldehydes. Especially interesting chemically reactive groups are acid anhydrides and acid halides (such as acid chloride), and-epoxides. These latter groups are particularly suited for reaction with the amine groups of biomolecules (or biomolecule analogues or derivatives thereof.

The term “biomolecule” should be understood in the broadest sense. With no intention to be limiting, examples of biomolecules include proteins, lipids, nucleic acids (such as RNA, DNA, etc), oligonucleotides, oligonucleotide analogues (such as PNA, LNA, etc.), cells, microorganisms, etc. as well as derivatives,thereof. Particularly interesting derivatives are those which includes an amine group suitable for coupling to the solid surfaces prepared as described herein. Other particularly interesting groups are thio and phosphate groups.

When returning to the chemically reactive groups,it has been found that particularly interesting chemically reactive groups are those which can readily react with biomolecules without the need for activation of the chemically reactive groups or the reactive groups of the biomolecule, e.g. without the need for a coupling reagent.

The method of the invention includes the step of treating the substrate in a plasma with a monomer gas comprising one or more types of monomers which is plasma polymerised onto the surface to thereby provide the surface of the solid substrate with chemically reactive groups.

Most often the monomers comprise a polymerisable group in addition to the groups which give rise to the chemically reactive groups on the solid substrate. Such a polymerisable group is typically selected from ethylenically unsaturated groups such as vinyl, propen-1-yl, propen-2-yl, acetylene, etc. and mono-, di-, or tri-substituted aromatic compounds. It should be understood that the individual monomers may comprise more than one group which primarily is intended for polymerisation (e.g. acrylic acid anhydride) and more than one group which primarily is intended to give rise to the chemically reactive group (e.g., 1,2-di-thiol-benzene).

Examples of useful monomers are methacrylic acid anhydride, acrylic acid chloride, acrylic acid, methacrylic acid, acrylic acid anhydride, 4-pentenoic anhydride, methacrylic acid chloride, acrolein, methacrolein, 1,2-epoxy-5-hexene, glycidylmethacrylate, allylamine, and allylmercaptane. Presently preferred monomers are methacrylic acid anhydride, acrylic acid chloride, acrolein, and glycidylmethacrylate.

It should be mentioned that the monomer gas may comprise more than one type of functional monomer.

The selected type of monomer may have a great influence on the surface tension of the functionalised substrate. Acid anhydrides used as monomers will normally render the surface quite hydrophilic whereas acid halogenides will render the surface quite hydrophobic. Very hydrophobic surfaces may make it more difficult to bring an aqueous solution of a biomolecule in contact with the functionalised surface, whereas a very hydrophilic surface will make it difficult to control the accurate spotting of aliquots of an aqueous solution. It may thus be desirable to include a modifying monomer in the monomer gas so as to prepare a copolymer with modified properties, i.e. a copolymer which will provide a surface which is more balanced in relation to the solution in which the biomolecule is provided. The modifying monomer may e.g. be a monomer free of chemical groups, which react with biomolecules without further initiation.

Examples of such monomers which may be used to adjust the surface tension are monomers being relatively hydrophobic (e.g. perfluorohexene, perfluoromethylpentene, hexene, pentene, propene, ethylene, cyclohexene, acetylene, styrene, xylene, vinylbornene, tetra-methylsilane, hexamethyl-di-silane, etc.) and monomers being relatively hydrophilic (e.g. vinylacetate, vinylpyrolidone, ethyleneglycolvinylether, diethyleneglycolvinylether, methacrylate, methylmethacrylate, allylalcohol, etc.).

As an illustrative example, acid anhydrides (hydrophilic) are advantageously combined with hydrophobic monomers such as hexene or styrene (hydrophobic), whereas acid chlorides (hydrophobic) advantageously are combined with vinyl acetate (hydrophilic).

The selected type of monomer may also have a great influence on the mechanical strength of the functionalised substrate. Monomers whose chemically reactive group makes up the major part of the monomer will normally render the surface mechanically rather weak. It may thus be desirable to include another (non-reactive) monomer in the monomer gas so as to prepare a copolymer with higher mechanical strength.

As an illustrative example, acid halides are advantageously combined with strength providing monomers such as hexene, styrene or xylene (hydrophobic) or with vinyl acetate (hydrophilic) or with methyl methacrylate.

In one preferred embodiment, the monomer gas further comprises a second monomer (such as the above hydrophilic, hydrophobic or strength providing monomers) which after plasma polymerisation with the one or more type of monomers gives rise to a co-polymer.

The relative molar ratio between the “chemically reactive” monomer and the hydrophobic/-hydrophilic strength providing monomer may e.g. be in the range of 1:1 to 1:100 mol/mol, when such a second monomer is used.

The plasma reaction chamber useful in the method of the invention can basically be of any conventional type, which can provide the desired plasma i.e. as defined in the claims. An applicable reaction chamber is the one described by the applicant in the earlier WO 00/44207 or those utilising the electrode system described in EP 0 741 404 B1.

The plasma type advantageously used in the concept of the present invention is one generated by a multiple phase AC supply or a DC supply. It has been found that this type of plasma has a level of intensity, which allows a substantial portion of the chemically reactive groups to be preserved. It is particularly advantageous to utilise a two or three phase AC plasma which offers the possibility of using a sufficiently low energy, e.g. energy levels of at the most 5 W/I such as at the most 3 W/I. Preferably, the intensity of the plasma is at the most 2.0 W/I, e.g. at the most 1.7 W/I. such a at the most 1.5 W/I, preferably at the most 1.2 W/I, in particular at the most 1.0 W/I, especially at the most 0.7 W/I. Most preferably the intensity of the plasma is between 0.5 and 2 W/I. It has been shown in the examples that even these surprisingly low plasma intensities provide very useful functionalised substrates.

The pressure in the reaction chamber will normally be in the range of 10-1000 μbar, such as 25-500 μbar or alternatively such as 20-300 μbar. The pressure in the reaction chamber is controlled by a vacuum pump optionally including a gas flow reduction valve, and a supply of the monomer gas and a carrier gas which may be an inert gas or a reactive gas or a mixture thereof. The inert carrier gas is suitably a noble gas such as helium, argon, neon, krypton or a mixture thereof. The reactive carrier gas may preferably be selected from the group consisting of hydrogen, oxygen, fluor, chloride or mixtures thereof.

Hence, a plasma reaction chamber can be adapted in accordance with the instructions given herein with possible modification obvious for the person skilled in the art.

The monomer concentration and the total treatment time should preferably be sufficient to provide the basis substrate surface with a plasma polymerised layer, preferably having a thickness of at least about 5 angstroms, such as between 10 and 1000 angstroms or higher.

The plasma polymerisation process is normally conducted for a period of 1-1000 sec, such as 10-100 sec.

The plasma polymerised layer typically has a substantially uniform thickness. It is believed that the layer thickness generally is in the range of 5-5000 nm, such as in the range of 1-1000 or 10-1000 nm, typically 10-200 nm, such as 5-50 nm.

The method of the invention is applicable for providing surfaces (polymerised layers) where preferably at least 1 mole-%, such as at least 3 mole-%, e.g. at least 5 mole-%, of the chemically reactive groups provided with the monomer gas to the plasma are present at the surface of the substrate i.e. in the polymerised layer. In one embodiment, a fraction e.g. 5% or 25% or more of the chemically reactive groups.in the polymerised layer may be available for reaction with biomolecules, whereas other groups may be embedded in the plasma polymerised layer.

It has been found that the method of the invention can provide substrates where the density of the chemically reactive groups on the substrate surface which has been treated with plasma is at least 0.001 nmol per cm², such as at least 0.005 nmol per cm², e.g. at least 0.01 nmol per cm². It is envisaged that even higher densities can be obtained if desirable, see, e.g., example 7 where 0.1 nmol/cm² of activated group was demonstrated to react with the primary amine of an organic molecule.

Thus, apart from the method described above, the present invention also provides a substrate obtainable according to the method defined above. Such substrate should preferably comprise plasma polymerised monomers selected from acid anhydrides, acid halides (such as acid chlorides), carboxylic acids, epoxides, aldehydes, and thiols, preferably from acid anhydrides, epoxides, and acid halides, in particular acid anhydrides, epoxides, and acid chlorides. Such as substrate preferably has a density of the chemically reactive groups accessible for chemical reaction of at least 0.001 nmol per cm².

Particularly preferred substrates include

a substrate comprising acid anhydride functionalities, wherein the density of the acid anhydride groups accessible for chemical reaction is at least 0.001 nmol per cm²,

a substrate comprising acid halide functionalities, wherein the density of the acid halide groups accessible for chemical reaction is at least 0.001 nmol per cm²,

a substrate comprising epoxy functionalities, wherein the density of the epoxy groups accessible for chemical reaction is at least 0.001 nmol per cm²,

Apart from biomolecules, it should be understood that other molecules, e.g. low molecular weight molecules, may also be coupled to the substrates prepared as described herein. Thus, the substrates may be used to immobilise peptides, amino acids organic spacers, etc.

A further aspect of the invention relates to a process for immobilising a chemical compound to a surface of a solid substrate, the process comprising the following steps:

(i) providing a substrate as described above, and optionally activating the chemically reactive groups of the substrate surface;

(ii) contacting the surface of the substrate with a solution comprising the chemical compound to be immobilised so as to allow reaction between the chemically reactive groups of the substrate and the chemical compound.

In one embodiment the solution comprising the protein or nucleic acid or analogue thereof does not include a coupling agent, i.e. the reaction between the chemically reactive groups of the substrate and the biomolecule (or biomolecule analogue or derivative thereof preferably takes place without activation.

Thus, it is generally preferred that the chemically reactive groups of the substrate surface need no activation, and that the process therefore does not include such activation step.

The chemical compound should preferably be selected from the group consisting of biomolecule or a biomolecule analogue or a derivative thereof as defined above. Preferably the chemical compound is proteins, lipids, nucleic acid, or analogue thereof, or mixtures thereof.

Such a process may comprise the subsequent step of rinsing the surface of the substrate so as to remove non-reacted biomolecule or biomolecule analogue or derivative, and/or so as to inactivate non-reacted activated chemically reactive groups.

When the hydrophobicity is suitable adjusted, it may be possible to present a number (e.g. 10-1000 or even more, of discrete spots of different biomolecules onto the same substrate, e.g. within an area of less than 10 cm².

The invention will be further illustrated by the following figures and examples.

### FIGURES

FIG. 1: Localisation of spots on a glass slide (examples 4 and 10) for coupling, upper row, and for hybridisation, lower row.

FIG. 2: Coupling of radio-labelled oligo to a slide (examples 4 and 10. Coupling capacities in the range of 0.004-0.012 nmol pr cm² was achieved.

FIG. 3: Hybridisation of oligo SGP4 to coupled oligonucleotides as described (example 10)

FIGS. 4a and 4b: A front view and a side view, respectively of an electrode system, which can be used when carrying out the invention.

### EXAMPLES 1

### Example 1

### Polymerisation of Styrene (S)

20 glass slides (1 inch.×3 inch.) were placed in a 300 L cylindrical plasma chamber equipped with a two phase electrode system as described in PCT DK01/00714. The slides were treated in three steps under the following conditions respectively: 1) Argon (Ar) plasma at pressure 0.025 mbar, power density 2.1 W/I, Ar flow 40 standard cubic centimetres per minute (sccm.), and duration 60 s, 2) Hydrogen plasma at pressure 0.025 mPa, H₂ flow 40 sccm., power density 2 W/I, and duration 60 s, 3) Polymerisation at 0.050 mbar, power density 0.2 W/I, Ar flow 10 sccm., S flow 200 sccm, and duration 60 s.

### Characterisation of the Resulting Coating

Advancing contact angle with deionised water was 90 deg. In comparison the value for untreated glass slides was less than 10 deg.

Fourier Transform Infrared spectroscopy (FT-IR): The presence of polystyrene was evidenced by absorption peaks in the following bands: 3100-3000 cm⁻¹ (Aromatic C—H), 3000-2800 cm⁻¹ (Aliphatic C—H), 1601 cm⁻¹ (Aromatic C—C), 1451 cm⁻¹ (Aliphatic C—H).

### Example 1B

### Polymerisation of Hexamethyldisilane (HMDSLAN)

17 glass slides were placed in a 300 L cylindrical plasma chamber equipped with a two phase electrode system as described in PCT DK01/00714. The slides were treated in 3 steps under the following conditions respectively: 1) Argon (Ar) plasma at pressure 0.025 mbar, power density 5.9 W/I, Ar flow 50 standard cubic centimetres per minute (sccm), and duration 60 s; 2) Argon/hydrogen (Ar/H₂) plasma at pressure 0.025 mbar, power density 6 W/I, Ar flow 35 sccm, H₂ flow 15 sccm, duration 60 s; 3) Polymerisation at 0.025 mbar, power density 6 W/I, Ar flow 35 sccm, HMDSLAN flow 100 sccm, and duration 60 s.

### Characterisation of the Resulting Coating

Advancing contact angle with deionised water was 90 deg. to 120 deg. In comparison the value for untreated glass slides was less than 10 deg.

Fourier Transform Infrared Spectroscopy (FT-IR): The presence of polyhexamethyldisilane is evidenced by absorption peaks in the following bands: 3000-2800 cm⁻¹ (aliphatic C—H), 2170-2140 cm⁻¹ (Si—H), 1270-1250 cm⁻¹ (Si—CH₃), 1030-1010 cm⁻¹ (Si—CH₂—Si) and 810-790 cm⁻¹ (Si—H).

### Example 1c

### Polymerisation of Hexene (Hex)

22 glass slides (1 inch.×3 inch.) were placed in a 300 L cylindrical plasma chamber equipped with a two phase electrode system (135 liters) as described in PCT/DK01/00714. The slides were treated in three steps under the following conditions respectively: 1) Ar plasma at pressure 0.013 mbar, power density 3.3 W/I, Ar flow 25 sccm, and duration 60 s, 2) Ar/H₂ plasma at pressure 0.013 mPa, Ar flow 17 sccm, H₂ flow 7 sccm., power density 2.0 W/I, and duration 60 s, 3) Polymerisation at 0.013 mbar, power density approximately 3.9 W/I, Ar flow 25 sccm., Hex flow 100 sccm, and duration 15 s.

### Example 2

### Polymerisation of Methacrylic Acid (MA)

24 polystyrene coated glass slides were placed in a 300 L cylindrical plasma chamber equipped with a three phase electrode system described in EP 0 741 404 B1. Plasma polymerisation of MA was carried out in the following way: Ar was bubbled through MA at 10 sccm. and fed to the chamber, and the polymerisation was carried out at pressure 0.10 mbar, power density 4.8 W/I, and duration 300 seconds.

### Characterisation of the Resulting Coating

Advancing contact angle with deionised water was less than 10 deg. In comparison the value for the polystyrene coated glass slides was 90 deg.

FT-IR: The presence of poly(methacrylic acid) was evidenced by absorption peaks in the following bands: 3000-2800 cm-1 (Aliphatic C—H), 1720-1700 cm-1 (Carboxylic acid), 1451 cm-1 (Aliphatic C—H). Furthermore a broad absorption peak in the band 4000-3000 cm-1 indicates the presence of hydroxyl and/or carboxylic acid.

### Example 3

### Polymerisation of Methacrylic Acid Anhydride (MAAH)

10 polystyrene coated glass slides were placed in a 300 L cylindrical plasma chamber equipped with a three phase electrode system described in EP 0 741 404 B1. Plasma polymerisation of MAAH was carried out in the following way: Ar was bubbled through MAAH at 5 sccm. and fed to the chamber, and the polymerisation was carried out at pressure 0.30 mbar, power density 2.7 W/I, and duration 300 seconds.

### Characterisation of the Resulting Coating

Advancing contact angle with deionised water was 30 deg. In comparison the value for the polystyrene coated glass slides was 90 deg.

FT-IR: The presence of poly(methacrylic acid anhydride) was evidenced by absorption peaks in the following bands: 3000-2800 cm⁻¹ (Aliphatic C—H), 1800-1740 cm⁻¹ (Carboxylic acid anhydride), 1451 cm⁻¹ (Aliphatic C—H). Furthermore a broad absorption peak in the band 4000-3000 cm⁻¹ indicates the preserce of hydroxyl and/or carboxylic acid.

### Example 4

### Polymerisation of Acrylic Acid Chloride (AACl)

60 polystyrene coated glass slides were placed in a 300 L cylindrical plasma chamber equipped with a three phase electrode system described in EP 0 741 404 B1. Plasma polymerisation of AACl was carried out under the following conditions: Pressure 0.1 mbar, power density 2.1 W/I, Argon flow 10 sccm., AACl flow 200 sccm, and duration 60 seconds.

### Characterisation of the Resulting Coating

FT-IR: The presence of poly(acrylic acid chloride) (PAACl) is evidenced by absorption peaks in the following bands: 3000-2800 cm⁻¹ (Aliphatic C—H), 1780-1740 cm⁻¹ (Carboxylic acid chloride), 1445 cm⁻¹ (Aliphatic C—H). However, significant absorption in the band 1730-1700 cm⁻¹ reveals that apart from PAACl the coating contains other carbonyl groups such as carboxylic acid, ester, and ketone. Furthermore a broad absorption peak in the band 4000-3000 cm⁻¹ indicates the presence of hydroxyl and/or carboxylic acid.

### Example 5

### Polymerisation of Acrylic Acid Chloride (AACl)

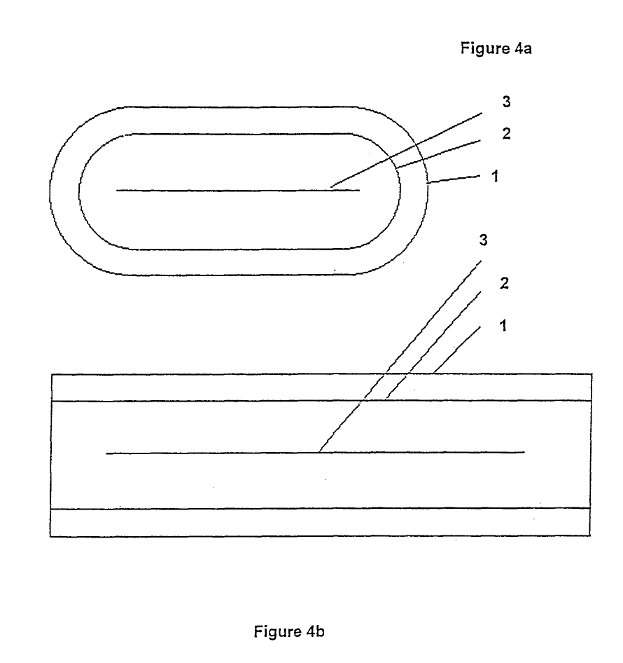

20 polystyrene coated glass slides were placed in a 300 L cylindrical plasma chamber equipped with a two phase electrode system described in PCT/DK01/00714. The electrode geometry is illustrate in FIGS. 4a and 4b showing a front view and a side view, respectively. The electrode geometry comprises two concentric electrodes 1,2, an outer electrode 1 and an inner electrode 2 circumferenced by the outer electrode 1. The outer electrode 1 consists of a 0.5 mm thick stainless steel plate bent to form a tube with an approximately elliptical cross section of width 500 mm, higth 240 mm, and length 1000 mm. The inner electrode 2 consists of a 1 mm thick stainless steel grid bent to form a tube with an approximately elliptical cross section of width 360 mm, higth 100 mm, and length 1000 mm. The substrates were placed on a stainless steel grid 3 electrically isolated from the electrodes 1,2 at the symmetry plane inside the inner electrode 1.

Plasma polymerisation of AACl was carried out under the following conditions: Pressure 0.025 mbar, power density 0.18 W/I, Argon flow 10 sccm., AACl flow 200 sccm, and duration 120 seconds.

### Characterisation of the Resulting Coating

FT-IR: The presence of polyacrylic acid chloride (PAACl) is evidenced by absorption peaks in the following bands: 3000-2800 cm⁻¹ (Aliphatic C—H), 1780-1740 cm⁻¹ (Carboxylic acid chloride), 1445 cm⁻¹ (Aliphatic C—H). However, significant absorption in the band 1730-1700 cm⁻¹ reveals that apart from PAACl the coating contains other carbonyl groups such as carboxylic acid, ester, and ketone. Furthermore a broad absorption peak in the band 4000-3000 cm⁻¹ indicates the presence of hydroxyl and/or carboxylic acid.

X-ray photon spectroscopy (XPS): Elementary composition (atomic %) of the upper approximately 5 nm: 13.6% Oxygen, 1.5% Nitrogen, 71.7% Carbon, 13.2% Chloride. The composition of the monomer is 20% O, 60% C, and 20% Cl. Thus the monomer has not been polymerised in stoichiometric ratio. However, a substantial amount of Cl is actually found in the resulting coating, and more important, the ratio of Cl to O is near 1:1 as is the case for acid chloride.

Interpretation of XPS data: Estimation of COCl and COOH concentrations from elementary composition of oxygen (O %) and chlorine (Cl %)

If FTIR shows only COCl (1780-1740 cm⁻¹) and COOH (below 1730-1710 cm⁻¹) and no presence of other carbonyl group —C═O (1800-1700 cm⁻¹), then the concentration of COCl and COOH can be estimated from the elementary composition of oxygen and chlorine.

Assuming the glass surface is totally covered by the coating, .i.e. Si %=0

1) If Cl %=O % then COCl %=Cl %=O % and COOH %=0

2) If Cl %<O % then COCl %=Cl % and COOH %=(O %-Cl %)/2

3) If Cl %>O % then (COCl) %=O % and Cl must be present in other forms than COCl, e.g. aliphatic (C—Cl).

### Example 5B

### Polymerisation of Acrylic Acid Chloride (AACl)

17 polyhexamethyidisilane coated glass slides were placed in a 300 L cylindrical plasma chamber equipped with a two phase electrode system as described in PCT/DK01/00714. Plasma polymerisation of AACl was carried out under the following conditions: Pressure 0.025 mbar, power density 0.28 W/I, Ar flow 25 sccm, AACl flow 200 sccm, and duration 60 s.

### Characterisation of the Resulting Coating

FT-IR: The presence of polyacrylic acid chloride (PAACl) is evidenced by absorption peaks in the following bands: 3000-2800 cm⁻¹ (aliphatic C—H), 1780-1740 cm⁻¹ (carboxylic acid chloride), and 1445 cm⁻¹ (Aliphatic C—H). Moreover, strong absorption peaks of HMDSLAN base coat were observed in the bands characteristic for HMDSLAN as described in example 1B.

Binding and hybridisation: Amine-terminated oligo-DNA probes were successfully bonded to the surface in excess of 0.002 nmole/cm². Subsequently the probes were successfully hybridised with complementary oligo-DNA.

### Example 6

### Polymerisation of AACl

20 polystyrene coated glass slides were placed in a 300 L cylindrical plasma chamber equipped with a three phase electrode system described in EP 0 741 404 B1. Plasma polymerisation of AACl was carried out under the following conditions: Pressure 0.15 mbar, Power density 2.1 W/I, Argon flow 10 sccm., AACl flow 200 sccm., reaction time 60 seconds.

### Characterisation of the Resulting Coating

FT-IR: The presence of polyacrylic acid chloride is evidenced by absorption peaks in the following bands: 3000-2800 cm⁻¹ (Aliphatic C—H), 1780-1740 cm⁻¹ (Carboxylic acid chloride). However, significant absorption in the band 1730-1700 cm⁻¹ reveals that apart from PAACl the coating contains other carbonyl groups such as carboxylic acid, ester, and ketone. Furthermore a broad absorption peak in the band 4000-3000 cm⁻¹ indicates the presence of hydroxyl and/or carboxylic acid.

### Example 6B

### Polymerisation of AACl

Polystyrene coated glass slide A was placed in a 300 L cylindrical plasma chamber equipped with a two phase electrode system as described in PCT/DK01/00714. Plasma polymerisation of AACl was carried out under the following conditions: Pressure 0.025 mbar, power density 1 W/I, Ar flow 10 sccm, AACl flow 200 sccm, and duration 120 s. Another polystyrene coated glass slide B was placed in the same plasma chamber. Plasma polymerisation of AACl was carried out under the following conditions: Pressure 0.100 mbar, power density 1 W/I, Ar flow 10 sccm, AACl flow 200 sccm, and duration 120 s.

### Characterisation of the Resulting Coating

FT-IR for both slides A and B: The presence of polyacrylic acid chloride (PAACl) is evidenced by absorption peaks in the following bands: 3000-2800 cm⁻¹ (aliphatic C—H), 1780-1740 cm⁻¹ (carboxylic acid chloride), and 1442 cm⁻¹ (Aliphatic C—H). Furthermore, FT-IR from slide B also reveals an absorption peak at 1710 cm⁻¹, indicating that apart from PAACl the coating contains other carbonyl groups such as carboxylic acid, ester and ketone. This peak is not present for slide A. Comparing the plasma polymerisation parameters for slides A and B, it seems that higher pressure results in other carbonyl groups than acrylic acid chloride.

X-ray Photoelectron Spectroscopy (XPS): Elementary composition (atomic % of the upper approximately 5 nm) of slide A: 11.9% oxygen, 73.7% carbon and 14.4% chlorine. For comparison, elementary composition of slide B: 12.8% oxygen, 1.3% nitrogen, 70.9% carbon, 15.0% chlorine. No major difference in elementary composition is observed betweeh slides A and B.

### Example 7

### Immobilisation of Amino Terminated Model Compound

Two slides (A1, A2) from example 4 were analysed by XPS. Another two slides (B1, B2) from the same batch were placed in aqueous solutions of borate buffer at pH=10. Three further (C1, C2, C3) from the same batch were likewise placed in borate buffer at pH=10 but with 2-bromo-ethylamine hydrobromide (BEA) added corresponding to 0.1 mole/l. To check for non-specific bonding, two polystyrene coated slides (D1, D2) were placed in 0,7 mole/l BEA solutions in borate buffer and de-ionised water, respectively. After 24 hours B1, B2; C1, C2, C3, D1 and D2 were rinsed with de-ionised water for two hours, then dried and analysed by XPS. The results (atomic %) are given in the table below.

| | | BEA conc. | | | | | | | |
|---|---|---|---|---|---|---|---|---|---|
| Sample | Coating | (mole/l) | pH | % C | % N | % Si | % O | % Cl | % Br |
| A1 | PS + PAACl | — | — | 77.2 | 1.2 | 0 | 11.8 | 9.8 | 0. |
| A2 | PS + PAACl | — | — | 77.2 | 1.2 | 0 | 11.8 | 9.8 | 0 |
| B1 | PS + PAACl | 0 | 10 | 71.7 | 1.5 | 1.2 | 15.0 | 10.6 | 0 |
| B2 | PS + PAACl | 0 | 10 | 71.6 | 1.7 | 0.9 | 14.5 | 11.3 | 0 |
| C1 | PS + PAACl | 0.1 | 10 | 72.9 | 4.2 | 0.2 | 14.1 | 8.3 | 0.2 |
| C2 | PS + PAACl | 0.1 | 10 | 73.3 | 3.8 | 0.2 | 14.0 | 8.5 | 0.4 |
| C3 | PS + PAACl | 0.1 | 10 | 73.0 | 3.6 | 0.2 | 14.4 | 8.6 | 0.3 |
| D1 | PS | 0.7 | 10 | 88.3 | 0.3 | 2.6 | 8.7 | 0.1 | 0 |
| D2 | PS | 0.7 | 8 | 90.8 | 0 | 1.5 | 7.5 | 0.1 | 0 |

From the table it can be seen that bromine is only found on the AACl treated samples, which were actually exposed to BEA. Non-specific bonding to polystyrene was not observed.

Comparing the atomic concentration of Cl and Br on B1, B2 and C1, C2, C3, one can see that the binding reaction between slides C1, C2, C3 and BEA caused a slightly decrease of Cl concentration and an increase of Br concentration from 0 to 0.3% on the slides. To calculate the binding capacity of COCl group to BEA; it is taken into account that the measuring depth of XPS is typically 5 nm, and that the binding reaction takes place only on the top monolayer of the surface. Assuming that 5 nm equals to the thickness of 25 monolayers, it is estimated that in the case of 10% of Cl on the slides as measured by XPS prior to the binding reaction with BEA corresponds to 0.4% of Br bound to the surface if the binding reaction is 100% efficient. As can be seen from the table, the Cl concentration was 11% (average of B1 and B2) before the binding reaction took place and the Br concentration was 0.3% (average of C1, C2 and C3) after the reaction. This indicates that the binding capacity of the coated COCl group is approx. 70%, which is quite high.

### Example 8

### Copolymerisation of AACl and Para-Xylene (pX)

20 polystyrene coated glass slides were placed in a 300 L cylindrical plasma chamber equipped with a two phase electrode system described in PCT/DK01/00714. Plasma co-polymerisation of AACl and pX was carried out under the following conditions: Pressure 0.025 mbar, Power density 0.3 W/I, Argon flow 10 sccm., AACl flow 100 sccm., pX flow 100 sccm., and reaction time 300 seconds.

### Characterisation of the Resulting Coating

FT-IR: The presence of poly(AACl-co-pX) is evidenced by absorption peaks in the following bands: 3100-3000 cm⁻¹ (Aromatic C—H), 3000-2800,cm⁻¹ (Aliphatic C—H), 1780-1740 cm⁻¹ (Carboxylic acid chloride), 1611 cm⁻¹ (Aromatic C—C), 1448 cm⁻¹ (Aliphatic C—H). However, significant absorption in the band 1730-1700 cm⁻¹ reveals that apart from poly(AACl-co-pX) the coating contains other carbonyl groups such as carboxylic acid, ester, and ketone. Furthermore a broad absorption peak in the band 4000-3000 cm⁻¹ indicates the presence of hydroxyl and/or carboxylic acid.

### Example 9

### Polymerisation of AACl

The influence of process parameters on the composition and thickness of the resulting coating was investigated in a series of experiments:

Two glass slides were placed in a 300 L cylindrical plasma chamber equipped with a two phase electrode system described in PCT/DK01/00714. Plasma polymerisation of AACl was carried out under the conditions given in the table below. Included in the table are the elementary composition (atom %) of the resulting coating as obtained by XPS and the maximum FT-IR absorbance peak height, ΔAₘₐₓ, in the band 1700-1800 cm⁻¹, which is an indirect measure of the thickness of the coating.

| | power | AACI | | | | | | | | | | |
|---|---|---|---|---|---|---|---|---|---|---|---|---|
| pressure | density | Flow | time | ΔAₘₐₓ | | | | | | | | |
| (μbar) | (W/l) | (sccm.) | (min.) | (%) | Oxygen | Nitrogen | Carbon | Silicium | Calcium | Sodium | Chloride | Tin |
| Untreated glass slide | | | | | 57.7 | 0.10 | 14.3 | 21.7 | 0.00 | 5.6 | 0.1 | 0.00 |
| 100 | 0.1 | 200 | 0.5 | 0.051 | 55.30 | 0.00 | 18.00 | 19.30 | 1.50 | 1.70 | 1.90 | 2.40 |
| 100 | 0.1 | 50 | 0.5 | 0.057 | 48.30 | 0.00 | 23.90 | 20.40 | 1.70 | 1.60 | 4.00 | 0.00 |
| 100 | 0.1 | 50 | 2 | 0.074 | 30.00 | 1.20 | 45.50 | 11.90 | 1.20 | 1.30 | 9.00 | 0.00 |
| 100 | 0.1 | 200 | 2 | 0.103 | 31.80 | 1.00 | 44.40 | 12.90 | 1.10 | 0.60 | 8.30 | 0.00 |
| 100 | 0.3 | 50 | 0.5 | 0.109 | 34.70 | 1.70 | 40.40 | 14.40 | 1.40 | 0.10 | 7.40 | 0.00 |
| 100 | 0.3 | 200 | 0.5 | 0.154 | 18.50 | 1.80 | 59.60 | 6.20 | 0.00 | 0.80 | 12.70 | 0.20 |
| 25 | 0.1 | 200 | 0.5 | 0.188 | 16.10 | 1.00 | 67.10 | 4.00 | 0.00 | 0.00 | 11.70 | 0.00 |
| 25 | 0.1 | 50 | 0.5 | 0.195 | 22.10 | 2.30 | 59.50 | 7.10 | 0.00 | 0.40 | 8.50 | 0.00 |
| 100 | 0.3 | 50 | 2 | 0.21 | 17.10 | 2.50 | 59.70 | 5.80 | 0.00 | 0.00 | 14.90 | 0.00 |
| 25 | 0.3 | 50 | 0.5 | 0.305 | 22.60 | 2.90 | 63.70 | 4.10 | 0.30 | 1.50 | 4.90 | 0.00 |
| 100 | 0.3 | 200 | 2 | 0.343 | 12.80 | 1.30 | 70.90 | 0.00 | 0.00 | 0.00 | 15.00 | 0.00 |
| 25 | 0.3 | 200 | 0.5 | 0.39 | 13.80 | 2.00 | 71.60 | 0.00 | 0.00 | 0.00 | 12.60 | 0.00 |
| 25 | 0.1 | 50 | 2 | 0.445 | 16.30 | 1.90 | 70.90 | 1.20 | 0.00 | 0.30 | 9.40 | 0.00 |
| 25 | 0.1 | 200 | 2 | 0.495 | 12.80 | 1.10 | 72.70 | 0.00 | 0.00 | 0.00 | 13.30 | 0.00 |
| 25 | 0.3 | 50 | 2 | 0.71 | 14.20 | 3.40 | 69.70 | 0.20 | 0.00 | 0.20 | 12.40 | 0.00 |
| 25 | 0.3 | 200 | 2 | 1.03 | 11.90 | 0.00 | 73.70 | 0.00 | 0.00 | 0.00 | 14.40 | 0.00 |

From the table it can be seen that the Silicium and Oxygen signals decrease and the Carbon signal increases as ΔAₘₐₓ increases, i.e. as the coating thickness increases Generally the lower pressure and the longer treatment time result in thicker coatings.

### Example 9B

### Polymerisation of Acrolein (Aldehyde Functionality)

Three glass slides (1 inch.×3 inch.) were placed in a 300 I cylindrical plasma chamber equipped with a two phase electrode system (135 liters) as described in PCT/DK01/00714. Acrolein was plasma polymerised under the following conditions:

Pressure 0.025 mbar, power density approximately 0.03 W/I, H₂ flow 15 sccm, Ar flow 35 sccm, acrolein flow 200 sccm, and duration 600 s.

### Example 9C

### Polymerisation of Glycidylmethacrylate (Epoxy Functionality)

17 glass slides (1 inch.×3 inch.) were placed in a 300 L cylindrical plasma chamber equipped with a two phase electrode system (135 liters) as described in PCT/DK01/00714. A polyhexene base coating was applied as described in example 1C. Subsequently glycidylmethacrylate was plasma polymerised under the following conditions: Pressure 0.025 mbar, power density approximately 0.3 W/I, Ar was bubbled through glycidylmethacrylate at 5 sccm, and duration 600 s.

### Example 10

### Immobilisation of Oligonucleotides (Oligo DNA)

Two slides (A1, A2) from example 4

Three oligonucleotides, SGP1, SGP3 and SGP6:

| | |
|---|---|
| SGP1: | 5′ TTT CAA CAT TAG TCG TCG GTC G-NH₂ 3′ |
| SGP3: | 5′ TTT CAA CAT TAG TCG TCG GTC G-OH 3′ |
| SGP6: | 5′ TTT AAA CGA TGG ATA GTT AAT-OH 3′ |

were applied for binding on an acrylic acid chloride plasma treated glass slide surface prepared according to example 4.

Initially the three oligos were radio labelled with T4 polynucleotide kinase (New England BioLabs). This enzyme catalyses the transfer of the terminal phosphathase group of gamma P-32 labelled adenosine triphosphate to the 5′-hydroxylated terminus of an oligonucleotide. The reaction was carried out for 30 min at 37° C. Labelled oligonucleotides were purified by EtOH precipitation, washed three times with cold 70% EtOH and examined by thin layer chromatography on silica gel plates (Merck) in 0.85 M KH₂PO₄.

Samples of labelled and unlabelled oligo (unlabelled oligos applied for hybridisation to a complementary oligo sequence, see later) were prepared in 50 mM borate buffer pH 10.2 with 10 pmol oligonucleotide per μl. For each 6 samples (SGP1, SGP3, SGP6 labelled and unlabelled, respectively) two 1 μl aliquots were spotted onto the slide surface for coupling, se FIG. 1, and incubated for 16 hrs at 22° C. in a sealed humidity chamber with saturated NaCl in water in the bottom. As shown in FIG. 1, spots in the upper row from the left are radio-labelled oligonucleotide SGP1, SGP3 and SGP 6, respectively, and in the lower row from the left SGP1, SGP3 and SGP6 unlabelled. Each oligo was spotted twice (side by side).

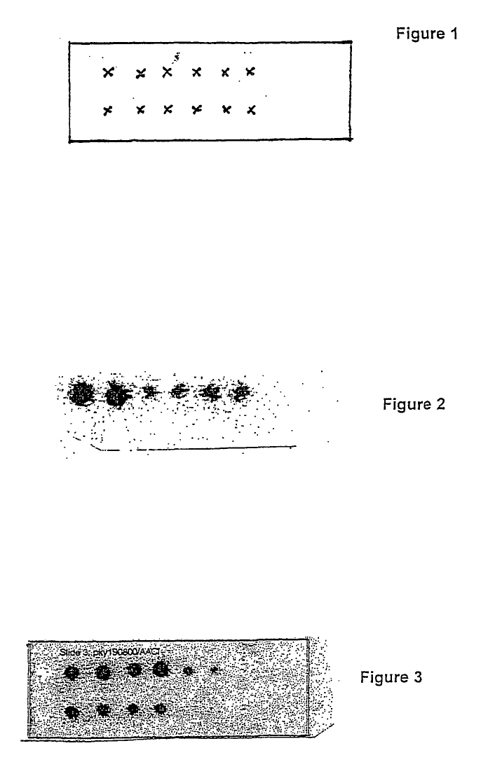

Subsequently the slide were washed 5 min at 50° C. in washing solution (50 mM ethanolamine; 0.1% SDS; 0.1 M Tris pH 9.0). Subsequently, the washing solution was discarded and a second wash was carried out in washing solution for 25 min at 50° C. Finally the slides were washed for 5 min in Milli-Q water at 22° C., dried and the coupling of labelled oligo was monitored together with a dried reference sample for each labelled oligo in 50 mM borate buffer pH 10.2. Monitoring was carried out using Instant Imager (Packard). The result is shown in FIG. 2, where it can be seen that coupling capacities in the range of nmol pr cm² was achieved. Please note that the intensity of spots for different oligos (see FIG. 1) must be compared to the reference (data not shown) and not to each other.

The average amount of coupled oligo SGP1, SGP3 and SGP6 were 0.012 nmol/cm², 0.004 nmol/cm², and 0.004 nmol/cm², respectively.

After coupling the slide were hybridised with oligo SGP4

SGP4: 5′ CGA CCG ACG ACT AAT GTT GAA A-OH 3′

complementary to SGP1 and SGP3 but not to SGP6. Prior to hybridisation, oligo SGP4 was radio-labelled and purified as described above for the other oligos.

Hybridisation was carried out in 100% relative humidity for 18 hrs at 50° C. in 5×SSC, 0.1% SDS, 0.1 μg/μl salmon sperm and 0.02 pmol labelled oligo SGP4. The hybridisation volume was 180 μl and the hybridization mix was covered with a cover slip. After hybridisation the slide was washed as follows: 5 min at 50° C. in 2×SSC; 0.1% SDS, 10 min at 22° C. in 0.2×SSC, 10 min at 22° C. in 0.1×SSC and finally 2 min at 22° C. in Millie-Q water. Subsequently the slide was dried and the hybridisation was monitored by the Cyclone Storage Phosphor System (Packard). The result of the hybridisation is shown in FIG. 3. Significant DNA hybridisation is demonstrated to oligo SGP1 and SGP3 (both complementary to oligo SGP4) and no hybridisation is detected for the negative control SGP6.

In Conclusion, deposition of a monomer onto a surface through plasma treatment has been demonstrated somehow to couple a biomolecule to the surface. Furthermore it has been shown that the biomolecule is coupled with strength and in a sterical manner that allows significant interactions with other biomolecules.

### Example 10A

### Immobilisation of Oligo DNA to Aldehyde and Epoxy Functionalised Slides

Oligonucleotides were applied for binding on an acrolein plasma, treated glass slide surface prepared according to example 9B and on a glycidylmethacrylate plasma treated glass slide surface prepared according to example 9C by the same binding procedure as described in example 10. The binding results are given in the table below.

| Functionality (monomer) | Surface concentration of oligo DNA |
|---|---|
| aldehyde (acrolein) | >0.5 nmole/cm² |
| epoxy (glycidylmethacrylate) | >0.5 nmole/cm² |

1. A method of providing a solid substrate with chemically reactive groups for immobilising chemical compounds, in particular biomolecules, the method comprising: providing a basis substrate, and treating the surface of the basis substrate with a monomer gas in a plasma, wherein said monomer gas comprising one or more types of monomers able to be plasma polymerised onto the surface and to provide the surface with chemically reactive groups, said one or more monomers having a concentration and said treatment of the surface being sufficient to provide the basis substrate surface with a plasma polymerised layer, and wherein said plasma is being generated by a power source selected from the group consisting of multiple phase AC supply and a DC supply, the level of intensity of said plasma allowing a substantial portion of the chemical reactive groups to be preserved.

2. A method according to claim 1, wherein the chemically reactive groups are selected from the group consisting of acid anhydrides, acid halides, epoxides, aldehydes, carboxylic acids, and thiols.

3. A method according to any one of the preceding claims, wherein said monomer comprises a chemically reactive group which can react with a biomolecule or a biomolecule analogues or a derivative thereof, preferably without further activation of the chemically reactive group.

4. A method according to any one of the preceding claims, wherein the chemically reactive group can react with an amino group of said biomolecule or biomolecule analogues or derivative, preferably said chemically reactive group can react and form a ionic bonding or more preferably a covalent bonding with the amino group of said biomolecule or biomolecule analogues or derivative.

5. A method according to any one of the preceding claims, wherein at least 1 mole-%, such as at least 3 mole-%, e.g. at least 5 mole-%, of the chemically reactive groups provided with the monomer gas to the plasma are polymerised onto the surface of the substrate.

6. A method according to any one of the preceding claims, wherein the density of the chemically reactive groups on the substrate surface is at least 0.001 nmol per cm², such as at least 0.005 nmol per cm², e.g. at least 0.01 nmol per cm².

7. A method according to any one of the preceding claims, wherein the monomers are selected from the group consisting of carboxylic acids (e.g. acrylic acid, methacrylic acid), acid anhydrides (e.g., acrylic acid anhydride, methacrylic acid anhydride, 4-pentenoic anhydride), acid halides (e.g., acrylic acid chloride, methacrylic acid chloride), aldehydes (e.g., acrolein, methadrolein), epoxides (e.g., 1,2-epoxy-5-hexene, glycidylmethacrylate), and thiols (e.g., 1-propanethiol, 1,2-di-thiol-benzene) and mixtures thereof.

8. A method according to any one of the preceding claims, wherein the intensity of the plasma is at the most 5 W/I, such as at the most 3 W/I, preferably at the most 2.0 W/I, e.g. at the most 1.7 W/I, such as at the most 1.5 W/I, preferably at the most 1.2 W/I, in particular at the most 1.0 W/I, especially at the most 0.7 W/I, most preferably between 0,5 and 2 W/I.

9. A method according to any one of the preceding claims, wherein the plasma is generated by a multiple phase AC supply, such as a two or three phase AC supply, or a multiple DC supply.

10. A method according to any one of the preceding claims, wherein the substrate is of a material selected from the group consisting of polymers, glass, paper, carbon fibres, ceramics, metals and mixtures thereof, preferably the substrate is of glass.

11. A method according to any one of the preceding claims, wherein the substrate comprises or preferably essentially consists of a polymeric material comprising one or more polymers selected from the group consisting of thermoplastics including polyolefins such as polyethylene (PE) and polypropylene (PP), polystyrene (PS), and other thermoplastics such as polytetrafluoroethylene (PTFE), tetra-fluoroethylene-hexafluoropropylen-copolymers (FEP), polyvinyldifluoride (PVDF), polyamides (e.g. nylon-6.6 and nylon-11), and polyvinylchloride (PVC), rubbers e.g. silicon rubbers, preferably the substrate is of polyethylene (PE) or polystyrene (PS).

12. A method according to any one of the preceding claims, wherein the monomer gas comprises a first and a second monomer which are different from each other and which monomers are plasma polymerised onto the substrate to form a co-polymer.

13. A substrate obtainable by the method as defined in any one of the claims 1-12.

14. A substrate according to claim 13, wherein the density of the chemically reactive groups on the substrate surface is at least 0.001 nmol per cm².

15. A substrate according to claim 13 comprising acid anhydride functionalities, wherein the density of the acid anhydride groups on the substrate surface is at least 0.001 nmol per cm².

16. A substrate according to claim 13 comprising acid halide functionalities, wherein the density of the acid halide groups on the substrate surface is at least 0.001 nmol per cm².

17. A substrate according to claim 13 comprising epoxy functionalities, wherein the density of the epoxy groups on the substrate surface is at least 0.001 nmol per cm².

18. A process for immobilising a chemical compound to a surface of a solid substrate, the process comprises the steps of:
(i) providing a substrate according to the method as defined in any one of the claims 1-12, and optionally activating the chemically reactive groups of the substrate surface;
(ii) contacting the surface of the substrate with a solution comprising the chemical compound to be immobilised so as to allow reaction between the chemically reactive groups of the substrate and the chemical compound.

19. A process for immobilising a chemical compound according to claim 18 wherein the chemical compound is selected from the group consisting of biomolecule or a biomolecule analogue or a derivative thereof, preferably said chemical compound being selected from the group consisting of lipids, proteins, nucleic acids, and analogues thereof, and mixtures thereof.

20. A process according to any one of the claims 18 and 19 further comprising the subsequent step of rinsing the surface of the substrate so as to remove non-reacted chemical compounds, and/or so as to inactivate non-reacted activated chemically reactive groups.

21. A process according to any of the claims 18-20, wherein the solution comprising the chemical compounds is substantially free of coupling agents.
